(19) United States
(12) Patent Application Publication
(10) Pub. No.: US 2010/0201328 A1
(43) Pub. Date: Aug. 12, 2010

(54) CHARGEABLE MOBILE SECURITY SYSTEM

(76) Inventor: MICHAEL G. MONSIVE, JR., Houston, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/370,427

(22) Filed: Feb. 12, 2009

(51) Int. Cl. H02J 7/04

(52) U.S. Cl. 320/162

(57) ABSTRACT

A security system with an internal chargeable power source is provided. The chargeable power source may be charged using techniques that may reduce dependence on external power sources. Such a security system may therefore be suitable for a wide range of applications including those with no readily available external power sources. For some embodiments, the security system generally includes surveillance equipment, a battery powering the surveillance equipment, a diesel engine-generator set (gen-set) for charging the battery, and control logic configured to control the charging of the battery by the diesel gen-set based on the output voltage of the battery.

### BACKGROUND OF THE INVENTION

1. Field of the Invention

Embodiments of the present invention generally relate to surveillance systems and, more particularly, to mobile surveillance systems with a chargeable power source and a charging power source.

2. Description of the Related Art

Security systems have found applications in various areas. Homes, warehouses, retail stores, construction sites, banks, automated teller machines (ATMs), etc., all use security systems. Deployment of security systems may help detect and/or prevent intrusions, theft, vandalism, and other mishaps.

Security systems may be used to monitor remote installations, sites, etc., where vandalism or theft may be common. Such security systems may comprise surveillance equipment like cameras, video recorders, and infrared devices to collect information about the remote installation or site.

Current security systems may typically use available external power sources (e.g., power from power lines of an electric grid stepped down by a transformer), as primary power sources. Such systems may not be suitable for deployment in areas with no electric grid power or other readily available external power sources. Furthermore, substitute power sources like batteries may only power the system for a limited duration.

Accordingly, what is needed are techniques and apparatus for powering a security system in an environment with no readily available power sources, for a long duration.

### SUMMARY OF THE INVENTION

One embodiment of the present invention provides an apparatus for surveillance. The apparatus generally includes surveillance equipment mounted on a pole, a chargeable power supply that provides power to the surveillance equipment, a charging power supply configured to charge the chargeable power supply, and control logic configured to control charging of the chargeable power supply by the charging power supply based on a detected parameter of the chargeable power supply.

Another embodiment of the invention provides an apparatus for surveillance. The apparatus generally includes surveillance equipment, a battery for powering the surveillance equipment, an alternator for charging the battery, a diesel engine for driving the alternator, and control logic configured to control charging of the battery by the diesel engine and the alternator based on a voltage of the battery.

Yet another embodiment of the invention provides a method for powering a surveillance apparatus. The method generally consists of monitoring a voltage of a chargeable power source supplying power to surveillance equipment, initiating charging of the chargeable power source with a charging power source when a voltage of the chargeable power source falls below a first threshold, and terminating charging of the chargeable power source when the voltage rises above a second threshold, wherein the second threshold is greater than or equal to the first threshold.

### BRIEF DESCRIPTION OF THE DRAWINGS

A more particular description of the invention, briefly summarized above, may be had by reference to the embodiments thereof which are illustrated in the appended drawings. It is to be noted, however, that the appended drawings illustrate only typical embodiments of the invention and are, therefore, not to be considered limiting in its scope, for the invention may admit to other equally effective embodiments.

FIG. 1 illustrates a mobile security system in accordance with certain embodiments of the present disclosure.

FIG. 2 illustrates a power unit within the system shown in FIG. 1 in accordance with certain embodiments of the present disclosure.

FIG. 3 illustrates a flow chart of example operations for charging a chargeable power source in accordance with certain embodiments of the present disclosure.

FIG. 4 illustrates a flow chart of example operations for controlling charging of a battery using a diesel engine-generator set in accordance with certain embodiments of the present disclosure.

### DETAILED DESCRIPTION

Certain embodiments of the present disclosure may provide a security system with an internal chargeable power source. The chargeable power source may be charged using techniques that may reduce dependence on external power sources. Such a security system may therefore be suitable for a wide range of applications, including those without a readily available external power source.

### Mobile Security System

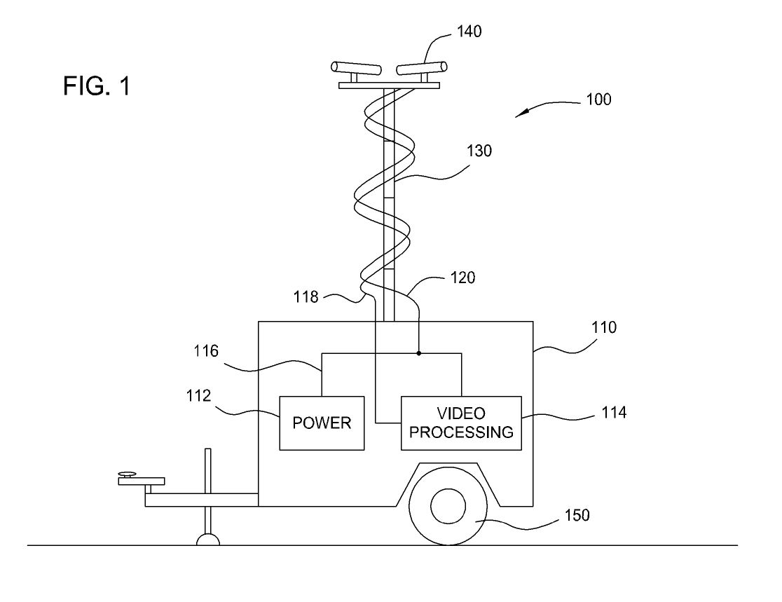

FIG. 1 shows a mobile security system 100 according to some embodiments of the present disclosure. The security system may be transported to and deployed in locations that may have no readily available power sources (e.g., construction sites), as well as to areas with an external power source, thereby expanding the number of suitable applications for such a system. In such locations, the security system 100 may be used, for example, to detect the presence of trespassers at a site, record their criminal activities with photographs or video, sound an audible alarm, alert authorities and/or a monitoring service, or any combination thereof. As illustrated in FIG. 1, the security system 100 may comprise a base unit 110, a pole 130, surveillance equipment 140, and wheels 150.

The base unit 110 may enclose a power unit 112 and a video processing unit 114. The power unit 112 may be configured to power the surveillance equipment 140 and the video processing unit 114 via a power cable 116. The video processing unit 114 may perform different video processing functions, such as video recording, image processing, time stamping, and video encoding. For example, the video processing unit may comprise a digital video recorder (DVR) or a video cassette recorder (VCR). Video and other signals from the surveillance equipment 140 may be input to the video processing unit 114 via the signal cable 118. Furthermore, the video processing unit 114 may control operation of the surveillance equipment 140 via the signal cable 118. For example, such control operations may include panning, tilting, or zooming operations of one or more cameras composing the surveillance equipment 140.

For some embodiments, the base unit 110 may comprise means to facilitate transportation and/or deployment of the system, such as a trailer assembly with wheels 150 as illustrated in FIG. 1. The trailer assembly may comprise any of various suitable components for transporting or operating the system 100. These may include any combination of the following: rear outriggers, a tongue jack, a lifting eye, taillights, etc. Some embodiments may use a sturdy trailer assembly that may be operational in wind gusts up to about 65 mph (104.6 kilometers per hour). For example, the trailer assembly may comprise rear outriggers for stabilizing the structure during strong wind gusts or when placed on an uneven surface.

Other embodiments may include means for transporting and/or deploying the security system 100 in a wheel-less manner. Such means may facilitate transportation and/or deployment of the security system 100 in areas not accessible by roads, such as those covered by ice or snow, areas located in a body of water, etc.

Certain embodiments of the present disclosure may provide means for supporting the surveillance equipment 140 at a suitable height above the base unit 110 in an effort to offer a clear view of a large surveillance area. For example, a mast or a pole 130 may support the surveillance equipment 140 when mounted on the base unit. The pole 130 may be removable from or statically mounted on the base unit 110. For some embodiments, the pole 130 may have a fixed length. For other embodiments, the pole may be a telescoping structure that may allow the height of the surveillance equipment 140 to be adjusted. For example, a galvanized three-section telescoping pole with adjustable height (e.g., 6 feet to 25 feet, or 1.83 m to 7.62 m) may be used. The means for telescoping the pole 130 may include electric winches, air cables, manual winches, twist lock, etc. For example, the height of the pole may be adjusted using a dual winch system. Some embodiments may comprise means for raising, lowering, or otherwise positioning the pole 130. For example, a hinge mechanism may be provided to allow the pole 130 to rotate between an approximately upright position for surveillance and a fully or at least a more prone position for transportation.

For other embodiments, the pole 130 may not be hinged. For such embodiments, the pole 130 may be stepped in a block or other fixture on the base unit 110 in an effort to conduct surveillance. When the surveillance equipment 140 is not in use, the pole 130 may be dismounted (i.e., removed from the block or other such fixture) and lowered in an effort to facilitate transportation and/or deployment.

The surveillance equipment 140 may comprise means for collecting information about the site in which the security system 100 is deployed. For some embodiments, the surveillance equipment 140 may comprise one or more surveillance cameras. A variety of cameras may be used. For example, some embodiments may use pan/tilt/zoom (PTZ) cameras or fixed cameras with built-in infrared (IR) for nighttime imaging. The collected information may be processed onsite by the video processing unit 114. For some embodiments, the surveillance equipment 140 may comprise any of various devices for detecting sound and/or motion such as audio recorders, motion sensors employing, e.g., lasers, or infrared sensors. Some embodiments may use surveillance equipment suitable for use in harsh environments involving high humidity and/or extreme temperatures.

The system 100 may include one or more alarms and means for activating the alarms. For example, a motion detector may be coupled with an audible or silent alarm to trigger the alarm when suspicious activity is detected. For some embodiments, the system 100 may comprise means for activating a remote siren that may be mounted away from the rest of the security system. For some embodiments, the alarm may include a light that turns on in an effort to deter trespassers and/or assist the camera(s) with imaging. Certain embodiments may include integrated global positioning system (GPS) tracking for increased functionality and security.

In some embodiments, the security system may comprise means for transmitting the collected and/or processed information to a different location to facilitate remote monitoring. For example, the security system may include high speed cellular, General Packet Radio Service (GPRS), Enhanced Data rates for Global Evolution (EDGE), satellite, Wi-Fi, WiMAX (Worldwide Interoperability for Microwave Access), mesh, and/or local area network (LAN) capabilities to transmit the information to a remote location for monitoring or further processing.

For some embodiments, the security system may send an e-mail, text message (Short Message Service, or SMS), or a paging notification to a remote site, personal computer (PC), server, or mobile device whenever an alarm has been triggered in an effort to alert someone. This message may include a video or a camera snapshot of the monitored site starting from when the alarm was triggered or shortly thereafter.

### Power Unit

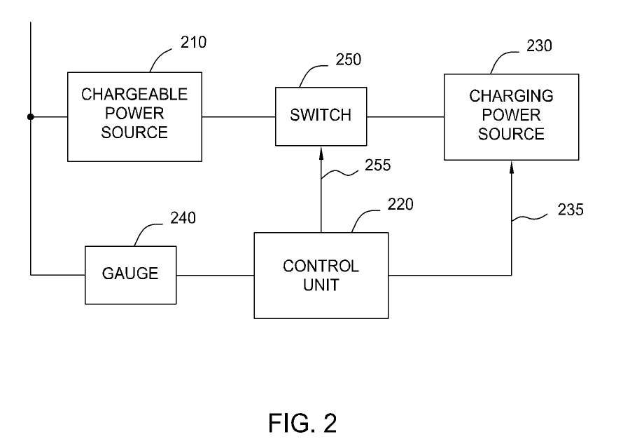

FIG. 2 illustrates an example power unit 112 in greater detail. The power unit 112 may comprise means for powering the surveillance equipment 140 and other system components. In the embodiment depicted in FIG. 2, the power unit may comprise five components: a chargeable power source 210, a control unit 220, a charging power source 230, a gauge 240, and a switch 250.

The chargeable power source 210 may be configured to power the surveillance equipment 140 and the video processing unit 114. The chargeable power source 210 may be any of various suitable devices capable of being repeatedly recharged and supplying sufficient power. In some embodiments, the chargeable power source 210 may comprise one or more rechargeable batteries. Any of various types of rechargeable batteries may be used. For example, the chargeable power source 210 may comprise one or more gel batteries (also known as gel cells), which contain battery acid in a gel form. For other embodiments, the chargeable power source 210 may comprise other types of lead-acid batteries, such as one or more absorbent glass mat (AGM) lead-acid batteries. The terminals of the chargeable power source 210 may be connected with the surveillance equipment 140 and the video processing unit 114 via the power cable 116 in an effort to provide power to the components of the system 100.

The charging power source 230 may provide means to charge the chargeable power source 210. For some embodiments, the charging power source 230 may be configured to generate power when signaled to do so by the control unit 220. The charging power source 230 may comprise any of various suitable power sources, such as generators that may convert mechanical energy into electrical energy, solar cells that may convert solar energy into electrical energy, etc., used alone or in combination. For some embodiments, the charging power source 230 may comprise an engine driving an alternator to charge the chargeable power source 210, similar to the engine/alternator/battery combination in a modern automobile. In such embodiments, the engine may comprise a diesel engine or an internal combustion engine (ICE) using any suitable fuel source, such as gasoline. The engine may comprise a single-cylinder or multiple cylinders and may be liquid-cooled or air-cooled. In addition to the engine and alternator, such a charging power source may include a fuel tank, an engine speed regulator, an alternator voltage regulator, cooling and exhaust systems, and a lubrication system.

For other embodiments, the charging power source 230 may comprise an engine-generator set (gen-set), which is the combination of an engine driving an electrical generator. Sometimes, the combination is simply referred to as a generator, taking the engine for granted. In addition to the engine and generator, the gen-set may include a fuel tank, an engine speed regulator, a generator voltage regulator, cooling and exhaust systems, and a lubrication system. As described above, the engine of the gen-set may comprise a diesel engine or an internal combustion engine (ICE) using any suitable fuel source, such as gasoline. The engine may comprise a single-cylinder or multiple cylinders and may be liquid-cooled or air-cooled. In the embodiments of charging power sources having an engine described above, the chargeable power source 210 or a separate source (e.g., a battery) may provide power to a starter motor for powering on the engine.

For still other embodiments, the charging power source 230 may comprise a gas engine generator (GEG) where the mechanical energy powering the electrical generator is heat energy from the burning of a gas. For example, the gas burned in a GEG may be natural gas or propane (liquid or gas).

As the efficiency of solar cells continues to improve, the charging power source 230 may comprise one or more solar panels in some embodiments. Each solar panel may comprise several solar cells and may be mounted on an upper or angled lateral surface of the base unit 110.

For some embodiments, the security system 100 may be configured to draw power from an external power source (not shown) whenever such a source is available. The external power source may comprise, for example, AC voltage (e.g., 110 V_{AC} or 220 V_{AC}) from an electric power grid. In such cases, the base unit 110 may include one or more electrical power outlets (also called receptacles or sockets) for receiving an AC power plug from an extension cord, for example. The type of electrical outlet(s) may be dependent on the type of electrical AC connector used in the country where the security system 100 is to be deployed. In other cases, the external power source may comprise an external battery.

While an external power source is provided, such security systems may draw power from this external source, perhaps charging or maintaining the chargeable power source 210 in some embodiments. In this manner, the external power source may function as a battery tender. Once the external power source is removed, the security system 100 may be powered from the chargeable power source 210 as described above, at least until the charging power source 230 is signaled to generate power by the control unit 220.

The control unit 220 may interface with a means for detecting one or more parameters of the chargeable power source 210 and may output a control signal 235 in an effort to power the charging power source 230 on or off. A meter, sensor, or a gauge 240—which in some embodiments may comprise an instrument, such as a digital voltmeter, ammeter, or power meter—may be configured to constantly measure one or more parameters of the chargeable power source 210. For example, the parameter being sensed may comprise voltage or power. For some embodiments, the gauge 240 may be part of the control unit 220, instead of a separate instrument. The same or a different instrument as the gauge 240 may be used to monitor the temperature of various components of the system 100, such as the chargeable power source 210, the alternator, or the generator itself.

The control unit 220 may monitor the parameter measured by the gauge 240 and, when the measured parameter falls below a first threshold value, use a control signal 235 to power on the charging power source 230. In some embodiments, a switch 250 may be used to interrupt the circuit between the charging power source 230 and the chargeable power source 210. The switch 250 may be used in embodiments where the charging power source 230 is typically or always powered on, even when the measured parameter of the chargeable power source 210 is above the threshold value. For other embodiments, the switch 250 may be utilized to prevent damages caused by in-rush current from a previously powered down charging power source when suddenly turned on. The switch 250 may be opened or closed by the control unit 220 via a control signal 255. The switch 250 may comprise any suitable electrical switching device capable of handling the current, such as an electromechanical (EM) relay or a solid-state device. When closed, the switch may act as a path for power from the charging power source 230 to flow to the chargeable power source 210.

Some embodiments may not include the switch 250. In such embodiments, the charging power source 230 may be connected with the chargeable power source 210, and the control unit 220 may be used to turn on or off the charging power source 230 via the control signal 235. In some embodiments, the power unit 112 may also comprise means for over-current protection (e.g., fuses), such as in the path between the chargeable power source 210 and the charging power source 230.

The control unit 220 may continuously or periodically monitor the parameter measured by the gauge 240. When the control unit 220 determines that the chargeable power source 210 is charged enough (i.e., when the parameter is greater than or equal to a second threshold, which may be greater than or equal to the first threshold), the control unit 220 may employ control signal 235 to power off the charging power source 230.

### Charging the Chargeable Power Source

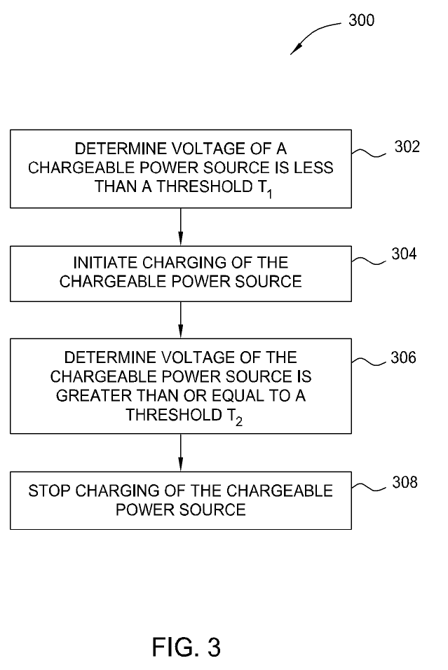

Different techniques may be used to determine when to charge the chargeable power source 210 and to control the charging itself. FIG. 3 illustrates example operations 300 for charging a chargeable power source, such as the power source 210 in FIG. 2. These operations 300 may be controlled by a control unit, such as the control unit 220 in FIG. 2, and may involve other components such as a gauge 240 for measuring one or more parameters of the chargeable power source 210 and a switch 250 to permit power flow to the chargeable power source. Control signals, such as the control signals 235 and 255 of FIG. 2, may be used to control operation of the charging power source 230 and the switch 250, respectively.

The operations 300 may begin at 302 with the control unit 220 determining that the output voltage of the chargeable power source 210 (as determined by the gauge 240, for example) is less than a threshold T₁. The value of T₁ may be chosen such that charging of the chargeable power source may start early enough to avoid disruption of normal operation of the surveillance equipment 140, video processing unit 114, and other components due to failure (i.e., low output voltage) of the chargeable power source 210.

At 304, the control unit 220 may initiate charging of the chargeable power source 210. To accomplish this, the control unit may use the control signal 235 in an effort to power on the charging power source 230. Following this, the switch 250 may be closed to permit power flow for embodiments that include the switch 250. By closing the switch after powering on the chargeable power source, damages due to transients from in-rush current, from example, may be avoided. Once the circuit path is completed (i.e., the switch is closed) and the charging power source 230 is powered on, the charging power source may begin recharging the chargeable power source 210 in an effort to raise the output voltage of the chargeable power source.

At 306, the control unit 220 may determine that the output voltage of the chargeable power source 210 (as determined by the gauge 240, for example) is greater than or equal to a second threshold T₂. T₂ may act as an indication that the chargeable power source is suitably charged, at least enough to power the surveillance equipment 140 and other components on its own, and the value of T₂ may be chosen accordingly. The value of T₂ may be greater than or equal to the value of T₁.

Following this, at 308, the control unit 220 may signal the charging power source 230 (e.g., via control signals 235 and/or 255) to stop supplying power by turning off the charging power source 230 and/or opening the switch 250. The gauge 240 may continue measuring the voltage so that the control unit 220 may determine when to charge the chargeable power source 210 again.

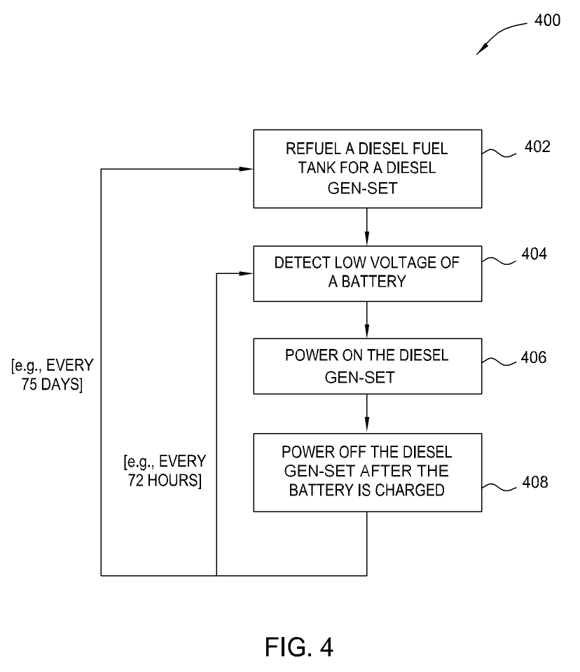

FIG. 4 illustrates example operations 400 for controlling charging of a battery using a diesel gen-set in accordance with certain embodiments of the present disclosure. The operations 300 of FIG. 3 may apply to the operations 400 of FIG. 4 where the chargeable power source 210 is a rechargeable battery and the charging power source 230 is a diesel gen-set. For the operations 400, a control unit such as the control unit 220 in FIG. 2 may be used to perform controlling and signaling operations. A gauge 240 and a switch 250, such as those described in relation to FIG. 2, may be used for measuring one or more parameters of the battery and controlling power flow to the battery, respectively. A control signal, such as control signal 235, may be used to power on/off the diesel gen-set, or more specifically, the diesel engine contained therein.

At the beginning of the operations 400, at 402, a diesel fuel tank for the diesel engine of the gen-set may be refueled. This may ensure that the diesel gen-set can be powered on to produce electrical power upon request.

At 404, the control unit 220 may detect a low output voltage of the battery (i.e., the chargeable power source 210) based on the value measured by the gauge 240, for example. At 406, the control unit 220 may power on the diesel gen-set via a control signal. At 408, the control unit 220 may power off the diesel gen-set after it determines that the battery is charged based on the value measured by the gauge 240, for example.

As described above, the diesel fuel tank may be refueled to ensure that the diesel gen-set may be powered on. Refueling may be done regularly. For example, a diesel gen-set, with a 30 gallon (113.56 liters) fuel tank, that consumes over 0.2 gallons (0.76 liters) per day may be refueled about every 75 days, as shown in FIG. 4. In the embodiment shown, the battery voltage may fall below a threshold used to determine when to charge the battery, about every 72 hours, depending on the age of the gelified electrolyte contained therein. Once this occurs, the diesel gen-set may be powered on to recharge the battery as illustrated in FIG. 4.

While the foregoing is directed to embodiments of the present invention, other and further embodiments of the invention may be devised without departing from the basic scope thereof, and the scope thereof is determined by the claims that follow.

1. An apparatus for surveillance, comprising:
surveillance equipment mounted on a pole;
a chargeable power supply for providing power to the surveillance equipment;
a charging power supply configured to charge the chargeable power supply; and
control logic configured to control charging of the chargeable power supply by the charging power supply based on a detected parameter of the chargeable power supply.

2. The apparatus of claim 1, wherein the pole is a telescoping pole.

3. The apparatus of claim 2, further comprising a winch for raising or lowering the telescoping pole.

4. The apparatus of claim 1, wherein the pole is removable.

5. The apparatus of claim 1, wherein the pole is coupled to a hinge mechanism.

6. The apparatus of claim 5, wherein the hinge mechanism allows for rotation of the pole between an approximately upright position and an approximately prone position.

7. The apparatus of claim 1, wherein the parameter comprises a voltage.

8. The apparatus of claim 7, wherein the control logic is configured to initiate charging of the chargeable power supply by the charging power supply when the voltage falls below a first threshold.

9. The apparatus of claim 8, wherein the control logic is configured to terminate charging of the chargeable power supply when the voltage of the chargeable power supply rises above a second threshold, wherein the second threshold is greater than or equal to the first threshold.

10. The apparatus of claim 7, further comprising a digital voltmeter for monitoring the voltage of the chargeable power supply.

11. The apparatus of claim 1, wherein the charging power supply comprises a diesel engine-generator set (gen-set), a gasoline gen-set, a gas engine generator (GEG), or a solar cell.

12. The apparatus of claim 1, wherein the chargeable power supply comprises a rechargeable battery.

13. The apparatus of claim 1, wherein the surveillance equipment comprises at least one of a camera, a motion sensor, an infrared (IR) sensor, a laser, a light, and an alarm.

14. The apparatus of claim 1, further comprising a video processing unit for receiving, processing, and/or storing images from the surveillance equipment.

15. The apparatus of claim 1, further comprising means for transporting the apparatus.

16. The apparatus of claim 15, wherein the means for transporting comprises a trailer assembly with wheels.

17. An apparatus for surveillance, comprising:
surveillance equipment;
a battery for powering the surveillance equipment;
an alternator for charging the battery;
a diesel engine for driving the alternator; and
control logic configured to control charging of the battery by the diesel engine and the alternator based on a voltage of the battery.

18. The apparatus of claim 17, wherein the surveillance equipment is mounted on a pole.

19. The apparatus of claim 18, wherein the pole is a telescoping pole.

20. The apparatus of claim 17, wherein the diesel engine comprises a single-cylinder diesel engine.

21. The apparatus of claim 17, further comprising a fuel tank for supplying fuel to the diesel engine.

22. The apparatus of claim 17, wherein the battery comprises a rechargeable gel battery.

23. The apparatus of claim 17, wherein the battery comprises an absorbent glass mat (AGM) lead-acid battery.

24. The apparatus of claim 17, wherein the surveillance equipment comprises at least one of a camera, a motion sensor, an infrared (IR) sensor, a laser, a light, and an alarm.

25. A method for powering a surveillance apparatus, comprising:
monitoring a voltage of a chargeable power source supplying power to surveillance equipment;
initiating charging of the chargeable power source with a charging power source when a voltage of the chargeable power source falls below a first threshold; and
terminating charging of the chargeable power source when the voltage rises above a second threshold, wherein the second threshold is greater than or equal to the first threshold.
